(19) United States
(12) Patent Application Publication
(10) Pub. No.: US 2006/0143985 A1
(43) Pub. Date: Jul. 6, 2006

(54) Long lasting window raiser

(75) Inventors: Jose Francisco Garcia Martin, Burgos (ES); Felix Nebreda De La Iglesia, Burgos (ES)

Correspondence Address: BIRCH STEWART KOLASCH & BIRCH, PO BOX 747, FALLS CHURCH, VA, 22040-0747, US

(73) Assignee: GRUPO ANTOLIN-INGENIERIA, S.A., Burgos (ES)

(21) Appl. No.: 11/316,733

(22) Filed: Dec. 27, 2005

(30) Foreign Application Priority Data
Dec. 28, 2004 (EP) 04380276.8

(51) Int. Cl. E05F 11/48

(52) U.S. Cl. 49/352

(57) ABSTRACT

A window raiser having: a first and second displacement means (10, 20); flexible connecting members (1); driving members (2) to which a winding drum of the flexible connecting members (1) is connected; a first and second redirecting members (100, 200); a first and second portions (110, 220) of the flexible connecting members (1). In the window raiser, the first portion (110) is configured to bend in a first direction in the first redirecting member (100) and in the cable winding drum connected to the driving members (2); the second portion (220) is configured to bend in a second direction in the second redirecting member (200) and in the cable winding drum connected to the driving members (2); the first direction coincides with the second direction.

### FIELD OF THE INVENTION

Double-rail cable window raiser systems.

### BACKGROUND OF THE INVENTION

The problem to be solved is centered on achieving an increase in the number of life cycles of double-rail cable window raiser system.

The window raiser systems must withstand a certain number of life cycles. This number of cycles usually varies between 30,000 and 50,000.

The most common way of failure in a double-rail window raiser is by cable fatigue in the area of the cable redirecting members and the area of the cable winding drum. In these areas, the cable is being bent and has to withstand alternate stresses due to the configuration of the kinematic chain, which causes the rupture of the cable after a certain number of cycles. What is understood as alternate stressing is explained next in the kinematic chain of conventional window raisers there are lengths of cable which are forced along their path to change direction by bending in one direction in the cable redirecting member and bending the opposite direction in the driving means, alternate stressing being produced which causes the premature wear of the cable.

Several proposals for attempting to obtain a cable window raiser the cable of which will withstand the stresses caused during its life are known in the state of the art:

U.S. Pat. No. 5,359,811 and U.S. Pat. No. 5,490,354: A window raiser system wherein different types of cable are used depending on the area where they are located is shown in these patents. Cables with high load capacities in the segments so requiring it are resorted to because they will have to withstand high stresses, and in the areas in which the stresses are lower, a type of cable with a lower load capacity is used. Thereby, the cable of the window raiser system is optimized by using high-strength cable segments (higher cost) in the areas of greater stressing.

EP0834634: a kinematic chain wherein two cable winding drums are used is protected in this patent; thus, the stresses withstood by one cable in a traditional configuration of the kinematic chain are distributed in two cables, whereby the working life of these cables is incremented.

### DESCRIPTION OF THE INVENTION

A first aspect of the invention relates to a window raiser having:

a first displacement means and a second displacement means:

configured to be connected to a windowpane,

spaced at a distance from each other,

configured to be displaced in unison and in parallel;

flexible connecting means connected to the first displacement means and the second displacement means for moving said displacement means along a stroke and moving the windowpane;

driving means to which a winding drum of the flexible connecting means located in an intermediate area delimited by the stroke of the displacement means is connected for moving the flexible connecting means along a path;

a first redirecting means, a second redirecting means, a third redirecting means, and a fourth redirecting means.

The flexible connecting means form a crossed, closed loop extending from the first displacement means around the first redirecting means and the second redirecting means to the second displacement means, and from the second displacement means around the third redirecting means and the fourth redirecting means back to the first displacement means.

Said flexible connecting means comprise:

a first portion from the first displacement means to the driving means;

a second portion from the driving means to the second displacement means;

a third portion from the second displacement means to the first displacement means.

The arrangement of the components of the window raiser is:

the first displacement means arranged between the fourth redirecting means and the first redirecting means along the path;

the second displacement means arranged between the second redirecting means and the third redirecting means along the path;

the first redirecting means arranged between the first displacement means and the driving means along the path;

the second redirecting means arranged between the driving means and the second displacement means along the path.

In accordance with the invention, the first portion around the first redirecting means and the cable winding drum connected to the driving means, the second portion around the second redirecting means and the cable winding drum connected to the driving means are configured to rotate (a change of direction being understood as a rotation) in the same direction. Along the paths of a first portion and a second portion, no alternate stressing occurs, that is, along the path of the first portion the flexible connecting means bend in the same direction in both the first cable redirecting member and the driving means, and along the path of the second portion the flexible connecting members bend in the same direction in both the second redirecting member and the driving members.

In other words, the first portion is configured to bend in a first direction in the first redirecting means and in the cable winding drum connected to the driving means; the second portion is configured to bend in a second direction in the second redirecting means and in the cable winding drum connected to the driving means; the first direction coinciding with the second direction.

Going into greater detail, the window raiser of the invention has:

a front portion;

a rear portion;

wherein:

the first displacement means and the second displacement means are displaced between an upper position and a lower position;

the second redirecting means is arranged in a position selected from upper front, lower front, upper rear, and lower rear.

In accordance with the invention, there can also be a window raiser wherein the third portion around the third redirecting means and around the fourth redirecting means is configured to rotate in the direction of the first portion around the first redirecting means and the cable winding drum connected to the driving means, the second portion around the second redirecting means and the cable winding drum connected to the driving means.

That is, the third portion is configured to bend in a third direction in the third redirecting means and the fourth redirecting means; the third direction coinciding with the first direction and the second direction. Along the path of this third portion, the flexible connecting means, or cable, bend in the same direction in both the third redirecting means, or pulley, and the fourth redirecting means.

The window raiser may further comprise:

a first sliding means arranged between the first redirecting means and the fourth redirecting means;

a second sliding means arranged between the second redirecting means and the third redirecting means;

for guiding the displacement of the first displacement means and the second displacement means.

The driving means to which the cable winding drum is connected are arranged in the intermediate area delimited by the path of the displacement means, that is, it is located in the intermediate area of the rails of the window raiser.

In the invention, the first sliding means, or first rail, and the second sliding means, or second rail, may be made up of the same element; either a first front sliding means is further used as a rear sliding means or a second rear sliding means is further used as a front sliding means.

On one hand, in the window raiser of the invention, the portions of the flexible connecting means may be selected from, for example, cable, tape, belt, and combinations thereof.

On the other hand, the redirecting means may be selected from, for example, pulleys, clips, and combinations thereof.

Likewise, the driving means may be selected from manual and electrical means.

Optionally, the flexible connecting means are made up of a single member. Alternatively, the flexible connecting means comprise:

a first component corresponding to the first portion;

a second component corresponding to the second portion;

a third component corresponding to the third portion.

### BRIEF DESCRIPTION OF THE DRAWINGS

Now, a series of drawings helping to better understand the invention and expressly related to an embodiment of said invention, presented as a non-limiting example thereof, will be very briefly described.

FIG. 1 is a diagram showing the second redirecting means in a lower rear position.

FIG. 2 is a diagram showing the second redirecting means in an upper rear position.

FIG. 3 is a diagram showing the second redirecting means in a lower front position.

FIG. 4 is a diagram showing the second redirecting means in an upper front position.

FIGS. 5 and 6 are two diagrams showing window raisers where the flexible connecting means bend around the first, second, third, and fourth redirecting means in the same direction.

FIG. 7 is a diagram of a conventional kinematic chain.

FIGS. 8 and 9 are two diagrams wherein bending of a conventional kinematic chain and in any of the alternatives of the kinematic chain of the invention is observed.

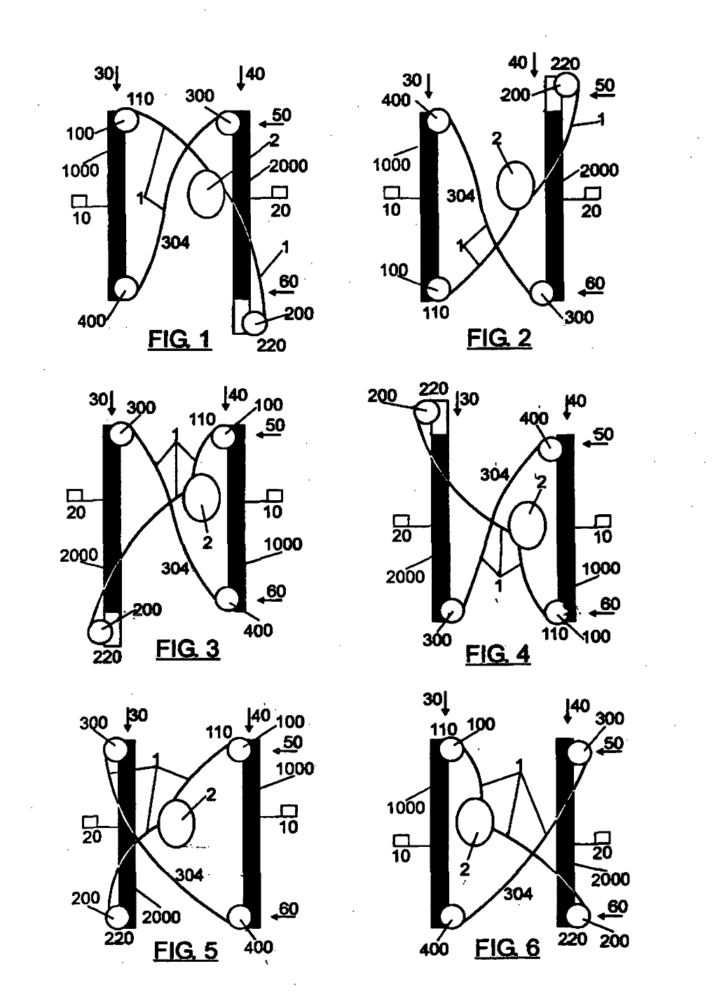

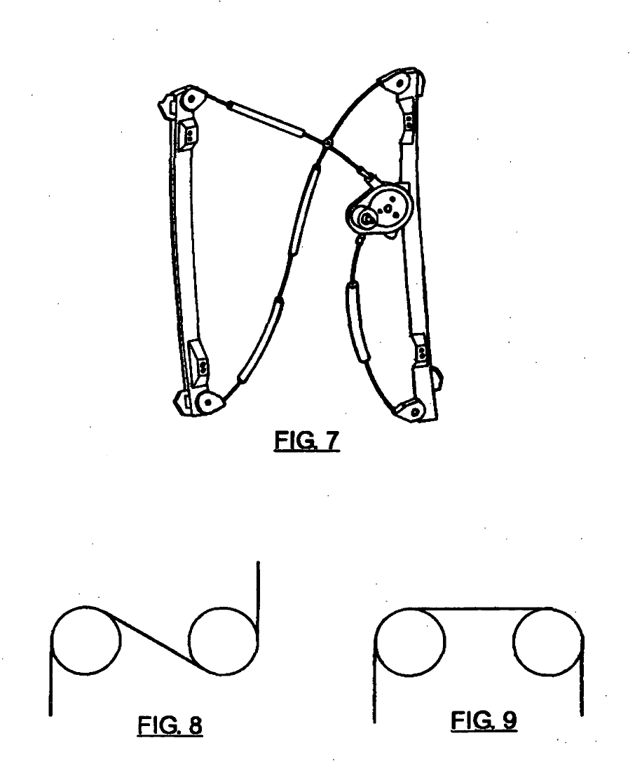

### DESCRIPTION OF A PREFERRED EMBODIMENT OF THE INVENTION

In accordance with the invention, the configuration of the kinematic chain of the window raiser is designed such that the cable or flexible connecting means 1 does not undergo an alternate stressing. There are two basic configurations:

In a first configuration, which in turn comprises four alternatives, the exit of the cable or flexible connecting means 1 of one of the pulleys, or second redirecting means 200, joining one of the carriages, or second displacement means 20, with the cable winding drum connected to the driving means 2, is changed. In a conventional kinematic chain, this cable or flexible connecting means 1 undergoes alternate stressing, that is, the cable, along its path through the different lengths which make it up, alternatively bends in the members of the kinematic chain in which it changes its direction, thereby causing the premature wear of the cable and its subsequent rupture, limiting the number of life cycles thereof.

In a conventional window raiser kinematic chain, three lengths or portions of cable or flexible connecting means may be differentiated:

a first portion running from a first carriage going through a first redirecting member or pulley to the driving means,

a second portion running from a second carriage going through a second redirecting member or pulley to the driving means, and

a third portion running from a first carriage to a second carriage going through a third redirecting means or pulley and a fourth redirecting means or pulley.

In a conventional kinematic chain illustrated in FIG. 7, it can be seen that in the first portion the cable bends in the same direction in both the first redirecting means and the cable winding drum connected to the driving means; however, it can be seen in the second portion of cable that the latter bends in a direction in the redirecting member and in the opposite direction in the cable winding drum, that is, the cable along the path of this portion bends alternately, causing a premature wear of the cable.

In the proposed configuration, the alternate stressing that occurs in this cable or flexible connecting means is eliminated by means of the modification of the kinematic chain of the window raiser.

The cable or flexible connecting means 1 joining both carriages or first and second displacement means 10, 20 is not subject to an alternate stressing because the distance between pulleys or redirecting means is greater than the stroke of the windowpane.

To prevent the appearance of an alternate stressing along the path of the flexible connecting means, the exit of the cable is changed in the redirecting means corresponding to the portion in which an alternate stressing exists; thereby, the cable corresponding to this portion has its exit towards the outside of the area comprised between the two rails of the window raiser. An alternate stressing is thereby prevented along the path of this length of cable.

Depending on the type of redirecting means 100, 200, 300, 400 and the carriages or displacement means 10, 20 used, the length of the rail or sliding means 2000 in which the exit of the cable or flexible connecting means 1 joining a carriage or second displacement means 20 with the winding drum from the cable driving means 2 is changed can be lengthened so that no interferences occur between both elements.

In a second configuration of the invention, the exit of the cable or flexible connecting means 1 of one of the pulleys or third redirecting means 300 joining the two carriages or first and second displacement means 10, 20 is further changed.

This configuration is achieved by means of the use of just one rail reference: just one type of rail is used for both the front rail and the rear rail. This configuration is specially advantageous in that is means saving one reference, without a specific type of rail being necessary depending on whether said rail is the front or rear one, entailing a cost reduction and a simplification of the window raiser assembly.

By means of the present invention, the working life of the cable and consequently that of the window raiser system are increased, achieving that the latter withstands a number of cycles far greater than conventional window raisers without incurring in an increase of the cost or complexity of the kinematic chain, as occurs with systems known in the state of the art.

With the present invention a long-lasting window raiser system is obtained by means of a new configuration of the kinematic chain of the window raiser. A double-rail cable window raiser system is made up of the following elements:

Rails or sliding means 1000, 2000: the profiles through which the carriages or displacement means 10, 20 of the window raiser can slide. They can be made up of metal profiles manufactured by means of cold molding, usually by rolling or stamping. They can also be manufactured by means of other processes such as light alloy injection or plastic injection.

Carriages or displacement means 10, 20: the connection members between the rails or sliding means 1000, 2000 and the windowpane. The carriages or displacement means 10, 20 slide along the rails or sliding means 1000, 2000 so as to cause the upward and downward movement of the windowpane. The carriages or displacement means 10, 20 are usually threaded in the rails or sliding means 1000, 2000 and are joined to the windowpane for example by screw driving.

Driving cable or flexible connecting means 1: it is the traction member of the system transmitting the movement from the driving member or driving means 2. Said driving member or driving means 2 may be both a manual system: handle, and an electrical system: reduction motor. In accordance with an embodiment of the invention, there are 3 cables: the first one joins the drum with one of the carriages, the second one joins the other carriage with the drum, and the third one joins the two carriages.

Driving system or means 2: it can be manual by means of a handle which is mounted on the cable winding drum or electrical by means of the use of a reduction motor which is connected to the cable winding drum. The drum to which the corresponding driving means is connected is made up of a grooved cylinder in which the cables are wound such that one of the cables, the one corresponding to a first portion, is wound in one direction and the one corresponding to a second portion is wound in the opposite direction.

Redirecting means 100, 200, 300, 400: they are the elements in charge of redirecting the cable or flexible connecting means 1. Typically, they are four made of plastic material and located at the ends of the rails or sliding means 1000, 2000. Hereafter, the term pulley will be used, but other elements performing the same redirecting function such as clips or the like may be used.

To obtain a long-lasting window raiser, a kinematic chain wherein the cable is not subject to an alternate stressing in the cable redirecting and cable winding drum areas has been designed. Further, several elements comprising the window raiser system have been optimized (type of cable, use of greases inside the drives, . . . ).

By preventing the alternate stressing in the areas where the cable is subject to a change of direction (cable redirecting pulleys and in the cable winding drum) a considerable increase in the working life of the cable of the window raiser system is achieved.

In the configuration illustrated in FIG. 1, there is shown that the exit of the cable of the pulley or second redirecting means 200 of lower rear position has been modified such that the cable exits towards the outside of the area limited by the rails of the window raiser. Thereby it is prevented that the cable joining the carriage or displacement means 20 that moves along the rail or sliding means 2000 located in the rear position 40 with the driving means 2 is subject to an alternate stressing, as the cable bends in the same direction in both the corresponding redirecting means and the cable winding drum.

Depending on the redirecting means 100, 200, 300, 400 and the carriages 10, 20 used, it may be necessary to lengthen the rail 1000, 2000 of the window raiser where the pulley in which the exit of the cable is going to be modified is located with respect to a conventional window raiser kinematic chain so that no interferences may occur between the pulley and the carriage.

In portion 304 of the flexible connecting means 1 no alternate stressing occurs due to the distance existing between the two pulleys 300, 400 being greater than the distance of the stroke of the windowpane.

In the configuration illustrated in FIG. 5, it is shown that the exit of the cable or flexible connecting means 1 has been modified in both the upper pulley or redirecting means 300 and the lower pulley or redirecting means 200 of the front rail 30. This configuration of the kinematic chain is achieved by means of the use of only one rail and pulley reference, that is, using the same type of rail for both the front rail and the rear rail.

Thereby, an alternate stressing is prevented:

In the second portion 220 of the cable or flexible connecting means 1 joining the carriage or displacement means 20 located in the front carriage 2000 with the cable winding drum or the driving means 2.

In the third portion 304 of the cable or flexible connecting means 1 joining both carriages or displacement means 10, 20, the one belonging to the front carriage 2000, and the one belonging to the rear carriage 1000, no alternate stressing occurs due to the length of the third portion 304 being greater than the stroke of the windowpane as in the previous configuration.

1. A window raiser having:
a first displacement means (10) and a second displacement means (20):
configured to be connected to a windowpane,
spaced at a distance from each other,
configured to be displaced in unison and in parallel;
flexible connecting means (1) connected to the first displacement means (10) and the second displacement means (20) for moving said displacement means (10, 20) along a stroke and moving the windowpane;
driving means (2) to which a winding drum of the flexible connecting means (1) located in an intermediate area delimited by the stroke of the displacement means (10, 20) is connected for moving the flexible connecting means (1) along a path;
a first redirecting means (100), a second redirecting means (200), a third redirecting means (300), and a fourth redirecting means (400);
said flexible connecting means (1) forming a crossed, closed loop extending from the first displacement means (10) around the first redirecting means (100) and the second redirecting means (200) to the second displacement means (20), and from the second displacement means (20) around the third redirecting means (300) and the fourth redirecting means (400) back to the first displacement means (10);
said flexible connecting means (1) comprising:
a first portion (110) from the driving means (2) to the first displacement means (10);
a second portion (220) from the driving means (2) to the second displacement means (20);
a third portion (304) from the second displacement means (20) to the first displacement means (10);
the first displacement means (10) being arranged between the fourth redirecting means (400) and the first redirecting means (100) along the path;
the second displacement means (20) being arranged between the second redirecting means (200) and the third redirecting means (300) along the path;
the first redirecting means (100) being arranged between the first displacement means (10) and the driving means (2) along the path;
the second redirecting means (200) being arranged between the driving means (2) and the second displacement means (20) along the path;
characterized in that:
the first portion (100) is configured to bend in a first direction in the first redirecting means (100) and in the cable winding drum connected to the driving means (2);
the second portion (220) is configured to bend in a second direction in the second redirecting means (200) and in the cable winding drum connected to the driving means (2);
the first direction coincides with the second direction.

2. The window raiser according to claim 1, having:
a front portion (30);
a rear portion (40);
wherein:
the first displacement means (10) and the second displacement means (20) are displaced between an upper position (50) and a lower position (60);
the second redirecting means (200) is arranged in a position selected from upper front, lower front, upper rear, and lower rear.

3. The window raiser according to claim 1, wherein:
the third portion (304) is configured to bend in a third direction in the third redirecting means (300) and the fourth redirecting means (400);
the third direction coincides with the first direction and the second direction.

4. The window raiser according to any of claims 1-3, further comprising:
a first sliding means (1000) arranged between the first redirecting means (100) and the fourth redirecting means (400);
a second sliding means (2000) arranged between the second redirecting means (200) and the third redirecting means (300);
for guiding the displacement of the first displacement means (10) and the second displacement means (20).

5. The window raiser according to claim 4, wherein: a first sliding means (1000) and a second sliding means (2000) are formed by a same element.

6. The window raiser according to claim 5, wherein: a first front sliding means (1000) is further used as a rear sliding means.

7. The window raiser according to claim 5, wherein: a second rear sliding means (2000) is further used as a front sliding means.

8. The window raiser according to any of claims 1-7, wherein the redirecting means (100, 200, 300, 400) are selected from pulleys, clips, and combinations thereof.

9. The window raiser according to any of claims 1-8, wherein the flexible connecting means (1) are made up of a single element.

10. The window raiser according to any of claims 1-8, wherein the flexible connecting means (1) comprise:
a first component corresponding to the first portion (110);
a second component corresponding to the second portion (220);
a third component corresponding to the third portion (304).
